(19) United States
(12) Patent Application Publication
(10) Pub. No.: US 2025/0242615 A1
(43) Pub. Date: Jul. 31, 2025

(54) METHOD FOR CONTROLLING PRINTING APPARATUS

(71) Applicant: SEIKO EPSON CORPORATION, Tokyo (JP)

(72) Inventors: Ryo HAMANO, MATSUMOTO-SHI (JP); Yutaka HISHIDA, SHIOJIRI-SHI (JP); Yasumichi OKUDA, MATSUMOTO-SHI (JP)

(21) Appl. No.: 19/034,720

(22) Filed: Jan. 23, 2025

(30) Foreign Application Priority Data
Jan. 26, 2024 (JP) 2024-009980

(51) Int. Cl. B41J 15/16; B41J 2/01

(52) U.S. Cl. CPC B41J 15/165; B41J 2/01

(57) ABSTRACT

A method for controlling a printing apparatus, the method including rotating a feeding shaft that supports a roll body so as to wind up a medium based on a winding direction data, and determining that a winding direction in the winding direction data matches a winding direction of the roll body supported by the feeding shaft when a tension bar that applies tension to the medium between a printing section that performs printing on the medium and the feeding shaft moves upward by the feeding shaft rotating, and determining that the winding direction in the winding direction data does not match the winding direction of the roll body supported by the feeding shaft when the tension bar moves downward by the feeding shaft rotating.

The present application is based on, and claims priority from JP Application Serial Number 2024-009980, filed Jan. 26, 2024, the disclosure of which is hereby incorporated by reference herein in its entirety.

### BACKGROUND

### 1. Technical Field

The present disclosure relates to a method for controlling a printing apparatus.

### 2. Related Art

JP 2012-254887 A describes a printing apparatus including a feeding shaft that feeds out a medium from a roll body, a printing section that performs printing on the medium fed out, and a tension bar that applies tension to the medium between the feeding shaft and the printing section.

In such a printing apparatus, an inward-wound roll body having a printing surface facing inward or an outward-wound roll body having a printing surface facing outward is set at the feeding shaft. The inward-wound roll body and the outward-wound roll body are different from each other in rotation direction of the feeding shaft when the medium is fed out. For example, in the case where the inward-wound roll body is set at the feeding shaft, when the feeding shaft rotates in one direction, the medium is fed out, and when the feeding shaft rotates in a reverse direction, the medium is wound up. In the case where the outward-wound roll body is set at the feeding shaft, when the feeding shaft rotates in the one direction, the medium is wound up, and when the feeding shaft rotates in the reverse direction, the medium is fed out.

Normally, in a printing apparatus, a user sets a winding direction of a set roll body. At this time, when there is an error in the setting, there is a risk that the printing apparatus cannot operate correctly.

### SUMMARY

A method for controlling a printing apparatus for solving the above-described problems is a method for controlling a printing apparatus in which winding direction data indicating a winding direction of a roll body around which a medium is wound is set, the method including rotating a feeding shaft that supports the roll body so as to wind up the medium based on the winding direction data, and determining that the winding direction in the winding direction data matches a winding direction of the roll body supported by the feeding shaft when a tension bar that applies tension to the medium between a printing section that performs printing on the medium and the feeding shaft moves upward by the feeding shaft rotating, and determining that the winding direction in the winding direction data does not match the winding direction of the roll body supported by the feeding shaft when the tension bar moves downward by the feeding shaft rotating.

A method for controlling a printing apparatus for solving the above-described problems is a method for controlling a printing apparatus in which winding direction data indicating a winding direction of a roll body around which a medium is wound is set, the method including rotating a feeding shaft that supports the roll body so as to feed out the medium based on the winding direction data, and determining that the winding direction in the winding direction data matches a winding direction of the roll body supported by the feeding shaft when a tension bar that applies tension to the medium between a printing section that performs printing on the medium and the feeding shaft moves downward by the feeding shaft rotating, and determining that the winding direction in the winding direction data does not match the winding direction of the roll body supported by the feeding shaft when the tension bar moves upward by the feeding shaft rotating.

### BRIEF DESCRIPTION OF THE DRAWINGS

FIG. 1 is a side view illustrating one example of a printing apparatus.

FIG. 2 is a side view illustrating a feeding unit.

FIG. 3 is a flowchart illustrating one example of determination processing.

FIG. 4 is a side view of the printing apparatus in which a roll body is set in a state in which a medium is loosened.

FIG. 5 is a flowchart illustrating one example of activation processing.

### DESCRIPTION OF EMBODIMENTS

Below, one example of a printing apparatus will be described with reference to the drawings. The printing apparatus is, for example, an ink jet-type printer configured to discharge ink serving as one example of a liquid to a medium such as a sheet or fabric to print an image of a character, a photo, or the like.

### Printing Apparatus

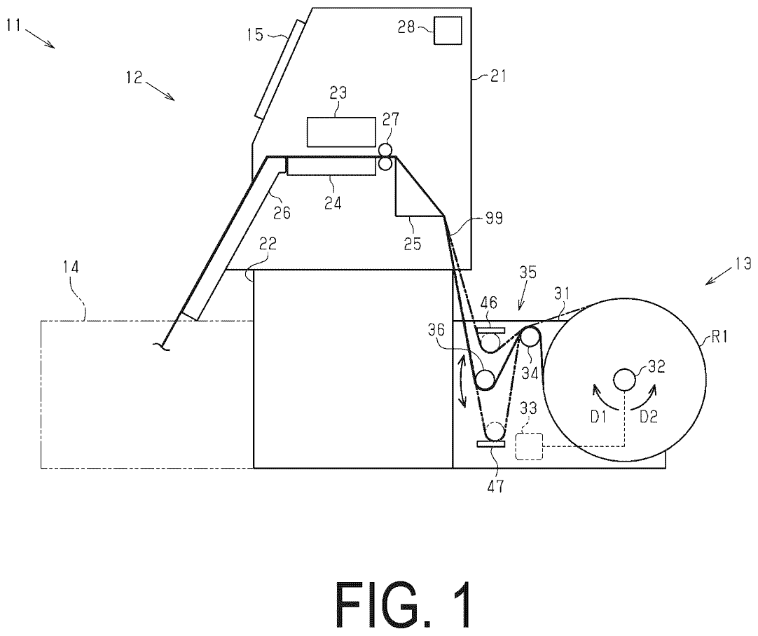

As illustrated in FIG. 1, a printing apparatus 11 includes a printing unit 12 and a feeding unit 13. The printing unit 12 is configured to perform printing on a medium 99. The feeding unit 13 is configured to feed out the medium 99. Specifically, the feeding unit 13 is configured to feed out the medium 99 from a roll body R1. The roll body R1 is an article around which the medium 99 is wound. The printing unit 12 and the feeding unit 13 will be described later.

The printing apparatus 11 may include a winding unit 14 that winds up the printed medium 99. The winding unit 14 is attached to the printing unit 12. The printing apparatus 11 may transport the printed medium 99 toward a winding device. In this case, the printed medium 99 is wound by the winding device.

The printing apparatus 11 includes a setting unit 15. The setting unit 15 is communicably coupled to the printing unit 12. The setting unit 15 is configured to set winding direction data. The winding direction data is data indicating a winding direction of the roll body R1 set at the feeding unit 13.

The setting unit 15 is configured to receive an operation by a user. The setting unit 15 sets the winding direction data by receiving a user's operation. The setting unit 15 may include a touch panel, may include a button, or may include a lever. The user specifies a winding direction of the roll body R1 set at the feeding unit 13 by operating the setting unit 15. Thus, winding direction data is set. The setting unit 15 may be an interface that communicates with an external device. In this case, the setting unit 15 sets winding direction data by receiving a user's operation from the external device. The external device is, for example, a personal computer, a smartphone, a tablet, and the like.

### Printing Unit

First, the printing unit 12 will be described. The printing unit 12 performs printing on the medium 99 fed out from the feeding unit 13. The medium 99 is wound by the winding unit 14 after printing is performed by the printing unit 12. The printing unit 12 performs printing on the medium 99 after the medium 99 is fed out by the feeding unit 13 and before the medium is wound by the winding unit 14. The printing unit 12 performs printing on a long-length medium 99 extending from the feeding unit 13 over the winding unit 14.

The printing unit 12 includes a housing 21. The printing unit 12 includes a leg section 22. The leg section 22 supports the housing 21.

The printing unit 12 includes a printing section 23. The printing section 23 is disposed within the housing 21. The printing section 23 is configured to perform printing on the medium 99. As one example, the printing section 23 is a head configured to discharge a liquid on the medium 99. The printing section 23 may be a serial head configured to scan with respect to the medium 99, or may be a line head configured to be able to discharge a liquid throughout a width of the medium 99 at the same time. The printing section 23 may perform printing on the medium 99 through toner jet, or may perform printing on the medium 99 through dot impact.

The printing unit 12 includes a support portion 24. The support portion 24 is disposed within the housing 21. The support portion 24 supports the medium 99. The support portion 24 is opposed to the printing section 23. The support portion 24 supports a region of the medium 99 on which printing is performed by the printing section 23.

The printing unit 12 may include an upstream support portion 25. The upstream support portion 25 may be disposed within the housing 21 or may be disposed outside of the housing 21. The upstream support portion 25 is disposed upstream of the support portion 24 in a transport direction of the medium 99. The upstream support portion 25 supports a region of the medium 99 that is disposed upstream of the region that the support portion 24 supports. By supporting the medium 99, the upstream support portion 25 guides the medium 99 from the feeding unit 13 to the support portion 24.

The printing unit 12 may include a downstream support portion 26. The downstream support portion 26 may be disposed within the housing 21 or may be disposed outside of the housing 21. The downstream support portion 26 is disposed downstream of the support portion 24 in the transport direction. The downstream support portion 26 supports a region of the medium 99 that is disposed downstream of the region that the support portion 24 supports. By supporting the medium 99, the downstream support portion 26 guides the medium 99 from the support portion 24 to the winding unit 14.

The printing unit 12 includes a transport unit 27. The transport unit 27 is configured to transport the medium 99. The transport unit 27 is disposed within the housing 21. The transport unit 27 transports the medium 99 to the printing section 23. The transport unit 27 transports the medium 99 fed out from the feeding unit 13. The transport unit 27 transports the medium 99 from the feeding unit 13 toward the winding unit 14. In one example, the transport unit 27 is disposed between the support portion 24 and the upstream support portion 25. The transport unit 27 includes, for example, a roller pair. In this case, by rotating in a state of interposing the medium 99, the transport unit 27 transports the medium 99.

The printing unit 12 includes a control unit 28. The control unit 28 is configured to control the printing unit 12. The control unit 28 controls, for example, the printing section 23 and the transport unit 27. The control unit 28 is configured to control the feeding unit 13. The control unit 28 is configured to control the winding unit 14.

The control unit 28 may be configured by one or more processors that execute various types of processing in accordance with a computer program. The control unit 28 may be configured by one or more dedicated hardware circuits such as an application-specific integrated circuit that executes at least a part of the various types of processing. The control unit 28 may be configured by a circuit including a combination of a processor and a hardware circuit. The processor includes a CPU, and memories such as a RAM and a ROM. The memory stores program codes or commands configured to cause the CPU to execute processes. The memory, i.e., a computer readable medium, includes any type of readable mediums that are accessible by general-purpose or dedicated computers.

The control unit 28 is coupled to the setting unit 15. The control unit 28 stores winding direction data. The control unit 28 executes processing of determining whether a winding direction indicated by the winding direction data matches a winding direction of the roll body R1 set at the feeding unit 13 or not. Processing executed by the control unit 28 will be described later.

### Feeding Unit

Next, the feeding unit 13 will be described. The feeding unit 13 is attached to the printing unit 12. In one example, the feeding unit 13 is attached to the leg section 22. The feeding unit 13 is disposed lower than the support portion 24. Thus, the feeding unit 13 feeds out the medium 99 upward toward the printing unit 12.

The feeding unit 13 includes a frame 31. The frame 31 is attached, for example, to the leg section 22. The frame 31 holds various types of components that the feeding unit 13 includes.

The feeding unit 13 includes a feeding shaft 32. The feeding shaft 32 is a shaft that supports the roll body R1. As the roll body R1 is supported by the feeding shaft 32, the roll body R1 is set at the feeding unit 13. As the feeding shaft 32 rotates, the medium 99 is fed out from the roll body R1. The feeding shaft 32 is attached to the frame 31.

The feeding shaft 32 is configured to be rotatable in both directions of a first direction D1 and a second direction D2. The second direction D2 is a reverse direction to the first direction D1. In FIG. 1, the first direction D1 is a clockwise direction, and the second direction D2 is a counterclockwise direction. The feeding shaft 32 is capable of winding up the medium 99 in addition to feeding out the medium 99.

The feeding unit 13 includes a driving unit 33. The driving unit 33 is configured to rotate the feeding shaft 32. The driving unit 33 rotates the feeding shaft 32 in the first direction D1 or the second direction D2. The driving unit 33 includes, for example, a motor. The driving unit 33 is coupled to the feeding shaft 32. As the driving unit 33 rotates the feeding shaft 32, the medium 99 is fed out from the first roll body R1, or the medium 99 is wound around the roll body R1.

The feeding unit 13 includes a guide roller 34. The guide roller 34 is attached to the frame 31. The medium 99 fed out from the roll body R1 is looped over the guide roller 34. In one example, the medium 99 is looped over the guide roller 34 from above. The guide roller 34 guides the medium 99 fed out from the roll body R1. Specifically, the guide roller 34 guides the medium 99 to a tension applying unit 35 that will be described later.

The feeding unit 13 includes the tension applying unit 35. The tension applying unit 35 is configured to apply tension to the medium 99. Specifically, the tension applying unit 35 comes into contact with the medium 99 after the medium 99 is fed out from the feeding shaft 32 and before the medium reaches the printing section 23, thereby applying tension to the medium 99. In one example, the tension applying unit 35 comes into contact with the medium 99 at a portion of the medium 99 between the feeding shaft 32 and the transport unit 27, thereby applying tension to the medium 99. With the tension applying unit 35 applying appropriate tension to the medium 99, the medium 99 is smoothly fed out from the feeding unit 13 toward the printing unit 12.

The tension applying unit 35 includes a tension bar 36. The tension bar 36 comes into contact with the medium 99. The tension bar 36 applies tension to the medium 99 between the feeding shaft 32 and the printing section 23. The medium 99 is looped over the tension bar 36. Specifically, the medium 99 guided by the guide roller 34 is looped over the tension bar 36. The tension bar 36 is disposed such that the medium 99 is looped over from below. Thus, by pressing downward the medium 99, the tension bar 36 applies tension to the medium 99. The tension bar 36 applies a certain amount of tension to the medium 99 under its own weight.

The tension bar 36 is configured to be displaced upward and downward. The tension bar 36 is displaced while applying a certain amount of tension to the medium 99. The tension bar 36 is displaced in accordance with a difference between a transport velocity of the medium 99 by the transport unit 27 and a feeding velocity of the medium 99 by the feeding shaft 32. When the transport velocity is faster than the feeding velocity, the medium 99 is pulled by the transport unit 27. In this case, as the transport unit 27 pulls the medium 99, the tension bar 36 moves upward. When the transport velocity is slower than the feeding velocity, the medium 99 is loosened. In this case, as the medium 99 is loosened, the tension bar 36 moves downward.

The control unit 28 controls the feeding velocity by the feeding shaft 32 such that the tension bar 36 is disposed at a predetermined position. Specifically, the control unit 28 controls the feeding velocity by the feeding shaft 32 such that the position of the tension bar 36 falls in a predetermined range. By positioning the tension bar 36 at the predetermined position, it is possible to apply appropriate tension to the medium 99. For example, when the tension bar 36 is disposed higher than the predetermined position, the feeding unit 13 increases the feeding velocity. When the tension bar 36 is disposed lower than the predetermined position, the feeding unit 13 reduces the feeding velocity. This makes it possible to keep the tension bar 36 in a state of being disposed at the predetermined position.

The tension bar 36 is a roller. Thus, the tension bar 36 rotates in association with feeding out of the medium 99. This reduces friction between the tension bar 36 and the medium 99, which makes it possible to smoothly transport the medium 99. The tension bar 36 may be configured, for example, with a rod that is unable to rotate.

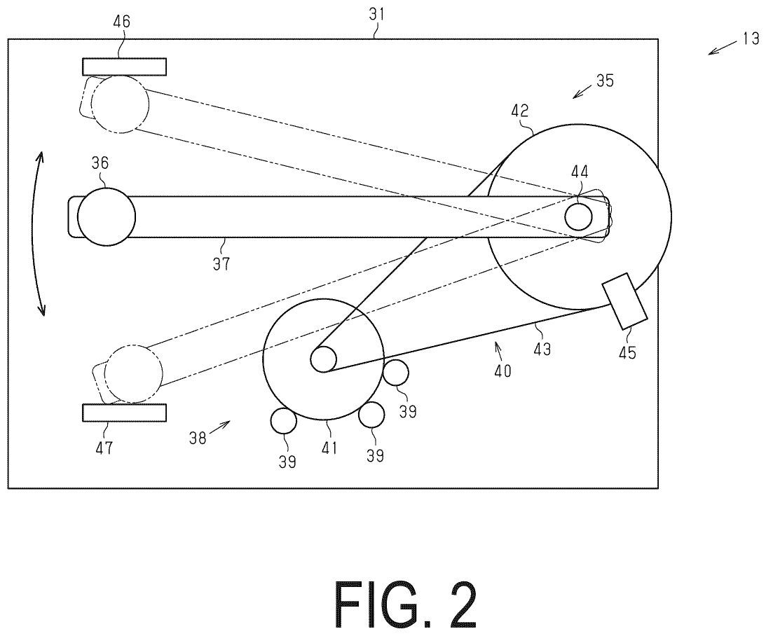

As illustrated in FIG. 2, the tension applying unit 35 includes an arm 37. The arm 37 supports the tension bar 36. Specifically, the tension bar 36 is attached at a tip portion of the arm 37.

The arm 37 is configured to rotate. Specifically, the arm 37 rotates with its base end portion being an axis. By rotating, the arm 37 causes the tension bar 36 to be displaced. That is, with the arm 37 rotating, the tension bar 36 moves upward and downward.

The tension applying unit 35 includes a rotary mechanism 83. The rotary mechanism 38 is a mechanism configured to cause the arm 37 to rotate.

The rotary mechanism 38 includes a motor 39. The rotary mechanism 38 may include a plurality of the motors 39. The motor 39 is configured to cause the arm 37 to rotate. The motor 39 causes the tension bar 36 to be displaced. The motor 39 may constitute the driving unit 33.

The rotary mechanism 38 includes a transmission mechanism 40. The transmission mechanism 40 is a mechanism configured to transmit power of the motor 39 to the arm 37.

The transmission mechanism 40 includes a driving gear 41, a driven gear 42, and a transmission belt 43. The transmission belt 43 is looped over the driving gear 41 and the driven gear 42. The driving gear 41 is coupled to the motor 39. The driving gear 41 is rotated by the motor 39. The driven gear 42 is coupled to the driving gear 41 through the transmission belt 43. This enables the driven gear 42 to follow the driving gear 41 and drive. As the driving gear 41 rotates, the driven gear 42 rotates.

The driven gear 42 includes a rotary shaft 44. The driven gear 42 rotates with the rotary shaft 44 being a center. The arm 37 is attached to the rotary shaft 44. The rotary shaft 44 is attached at the base end portion of the arm 37. As the rotary shaft 44 rotates, the arm 37 rotates. Thus, the driven gear 42 operates in conjunction with the arm 37. The rotary shaft 44 may be disposed so as to be coaxial with the feeding shaft 32.

The tension applying unit 35 includes a detection unit 45. The detection unit 45 is configured to detect movement of the tension bar 36. The detection unit 45 is configured to detect upward movement of the tension bar 36 and downward movement of the tension bar 36.

The detection unit 45 detects a rotational angle of the arm 37, to detect the movement of the tension bar 36. For example, the detection unit 45 includes an encoder. In one example, the detection unit 45 detects a rotational angle of the driven gear 42. The detection unit 45 converts the rotational angle of the driven gear 42 into a rotational angle of the arm 37. The detection unit 45 detects the rotational angle of the arm 37 to detect a change in the rotational angle of the arm 37. Thus, the detection unit 45 detects the movement of the tension bar 36. The detection unit 45 may detect not only the rotational angle of the driven gear 42 but also a rotation angle of the driving gear 41.

The detection unit 45 may detect a position of the tension bar 36 in addition to detecting the movement of the tension bar 36. For example, the detection unit 45 detects a position of the tension bar 36 from a rotational angle of the arm 37. The position of the tension bar 36 is controlled by the detection unit 45 detecting the position of the tension bar 36. Rotation of the feeding shaft 32 is controlled based on the position of the tension bar 36. Specifically, the rotation of the feeding shaft 32 is controlled such that the tension bar 36 is disposed at a predetermined position. By the control unit 28 controlling the motor 39, the feeding velocity by the feeding shaft 32 is controlled.

The detection unit 45 may include a plurality of position sensors. The detection unit 45 may detect movement of the tension bar 36 by detecting a position of the tension bar 36 using the plurality of position sensors. The detection unit 45 may include a distance sensor. The detection unit 45 may detect movement of the tension bar 36 by detecting a distance between the distance sensor and the tension bar 36.

The tension applying unit 35 may include one or more stoppers. As one example, the tension applying unit 35 includes an upper-side stopper 46 and a lower-side stopper 47. The stopper comes into contact with the tension bar 36 or the arm 37, thereby restricting movement of the tension bar 36 and the arm 37. That is, the stoppers limit a movement range of the tension bar 36. The upper-side stopper 46 and the lower-side stopper 47 are disposed so as to interpose the tension bar 36 from above and below. A gap between the upper-side stopper 46 and the lower-side stopper 47 is a movement range of the tension bar 36.

The upper-side stopper 46 comes into contact with the tension bar 36 or the arm 37. In one example, the upper-side stopper 46 comes into contact with the tension bar 36. Specifically, the upper-side stopper 46 comes into contact with the tension bar 36 from above. With this configuration, the upper-side stopper 46 restricts upward movement of the tension bar 36 and the arm 37.

The lower-side stopper 47 comes into contact with the tension bar 36 or the arm 37. In one example, the lower-side stopper 47 comes into contact with the tension bar 36. Specifically, the lower-side stopper 47 comes into contact with the tension bar 36 from below. With this configuration, the lower-side stopper 47 restricts downward movement of the tension bar 36 and the arm 37.

The control unit 28 may determine a reference angle of the arm 37 based on the fact that the upper-side stopper 46 or the lower-side stopper 47 restricts the movement of the tension bar 36. For example, the control unit 28 may determine a rotational angle of the arm 37 when the tension bar 36 is in contact with the upper-side stopper 46 as a reference angle. The control unit 28 may determine a rotational angle of the arm 37 when the tension bar 36 is in contact with the lower-side stopper 47 as a reference angle. When the detection unit 45 is a rotary encoder, a reference angle of the arm 37 serving as a measurement reference for the detection unit 45 is necessary. By counting an encoder pulse from the reference angle, the detection unit 45 detects a rotational angle of the arm 37. The reference angle may be stored in advance in the control unit 28. The reference angle may be updated based on the fact that the upper-side stopper 46 or the lower-side stopper 47 restricts the movement of the tension bar 36.

Specifically, the control unit 28 controls the motor 39 to bring the tension bar 36 into contact with the upper-side stopper 46 or the lower-side stopper 47. At this time, the control unit 28 detects that movement of the tension bar 36 is restricted by the stopper based on a torque of the motor 39 such as a load current of the motor 39. Specifically, when a load current corresponding to the toque of the motor 39 equal to or more than a predetermined torque flows through the motor 39, the control unit 28 detects that the movement of the tension bar 36 is restricted by the stopper. Thus, the control unit 28 sets, as the reference angle, the rotational angle of the arm 37 detected by the detection unit 45 in the state in which the load current corresponding to the toque of the motor 39 equal to or more than the predetermined torque flows through the motor 39.

### Controlling of Printing Apparatus

Next, controlling of the printing apparatus 11 will be described.

The roll body R1 wound inward or the roll body R1 wound outward is set at the feeding unit 13. Around the inward-wound roll body R1, the medium 99 is wound so that a printing surface faces inward. Around the outward-wound roll body R1, the medium 99 is wound so that a printing surface faces outward. The printing surface is a surface on which printing is performed by the printing section 23. The medium 99 needs to be fed out so that the printing surface faces the printing section 23. In an example illustrated in FIG. 1, the inward-wound roll body R1 is set at the feeding unit 13. When the outward-wound roll body R1 is set at the feeding unit 13, the medium 99 extends from the roll body R1 as indicated by an alternate long and short dash line in FIG. 1.

In the feeding unit 13, a rotation direction of the feeding shaft 32 when feeding out the medium 99 is different between the case where the inward-wound roll body R1 is set and the case where the outward-wound roll body R1 is set. For example, when the inward-wound roll body R1 is set as illustrated in FIG. 1, the medium 99 is fed out by the feeding shaft 32 rotating in the first direction D1. When the outward-wound roll body R1 is set, the medium 99 is fed out by the feeding shaft 32 rotating in the second direction D2. Therefore, the control unit 28 needs to grasp the winding direction of the roll body R1 supported by the feeding shaft 32.

The control unit 28 grasp the winding direction of the roll body R1 by winding direction data. However, there is a risk that the user sets wrong winding direction data. Therefore, the control unit 28 determines whether the winding direction data of the roll body R1 matches the winding direction of the roll body R1 supported by the feeding shaft 32.

Based on the movement of the tension bar 36 caused by the rotation of the feeding shaft 32, the control unit 28 determines whether the winding direction data of the roll body R1 matches the winding direction of the roll body R1 supported by the feeding shaft 32. For example, the control unit 28 rotates the feeding shaft 32 so as to wind up the medium 99 based on the winding direction data. The control unit 28 determines that the winding direction set in the winding direction data matches the winding direction of the roll body R1 supported by the feeding shaft 32 when the tension bar 36 moves upward as the feeding shaft 32 rotates, and determines that the winding direction set in the winding direction data does not match the winding direction of the roll body R1 supported by the feeding shaft 32 when the tension bar 36 moves downward as the feeding shaft 32 rotates. This is because when the feeding shaft 32 winds up the medium 99, the tension bar 36 moves upward by being lifted by the medium 99, and when the feeding shaft 32 feeds out the medium 99, the tension bar 36 moves downward by the medium 99 being loosened. In this way, the control unit 28 can determine whether the winding direction data of the roll body R1 matches the winding direction of the roll body R1 supported by the feed shaft 32 by rotating the feeding shaft 32. The control unit 28 can determine the winding direction of the roll body R1 based on the behavior of the tension bar 36 due to the rotation of the feeding shaft 32.

Next, one example of determination processing will be described. The determination processing is processing of determining whether the winding direction data of the roll body R1 matches the winding direction of the roll body R1 supported by the feeding shaft 32. The determination processing is executed by the control unit 28. The determination processing is executed based on an instruction from the user. For example, the determination processing is executed before printing is started by the user operating the setting unit 15.

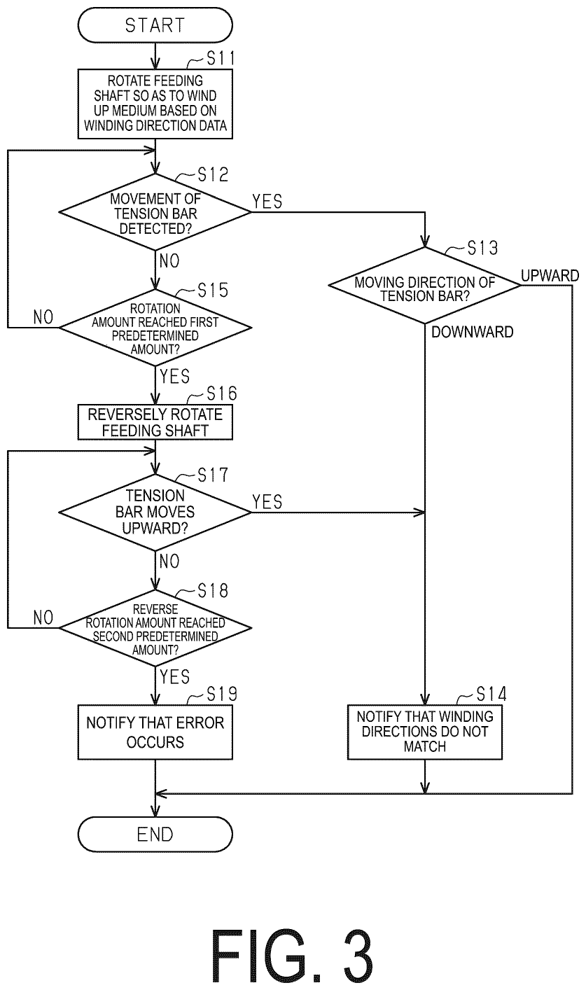

As illustrated in FIG. 3, in step S11, the control unit 28 rotates the feeding shaft 32 so as to wind up the medium 99 based on winding direction data. That is, in the example illustrated in FIG. 1, when the winding direction data indicates inward winding, the control unit 28 rotates the feeding shaft 32 in the second direction D2. In the example illustrated in FIG. 1, when the winding direction data indicates outward winding, the control unit 28 rotates the feeding shaft 32 in the first direction D1.

In step S12, the control unit 28 determines whether the detection unit 45 detects movement of the tension bar 36. When the detection unit 45 detects the movement of the tension bar 36, the control unit 28 transitions the processing to step S13. When the detection unit 45 does not detect movement of the tension bar 36, the control unit 28 transitions the processing to step S15.

In step S13, the control unit 28 determines whether a moving direction of the tension bar 36 is upward or downward. The control unit 28 determines whether the moving direction of the tension bar 36 is upward or downward based on a detection result by the detection unit 45. When the medium 99 is wound by the feeding shaft 32, the tension bar 36 is lifted by the medium 99. When the winding direction in the winding direction data matches a winding direction of the roll body R1 supported by the feeding shaft 32, the tension bar 36 moves upward. Therefore, when the moving direction of the tension bar 36 is upward, the control unit 28 determines that the winding direction in the winding direction data matches the winding direction of the roll body R1 supported by the feeding shaft 32. In this case, the control unit 28 determines that the winding direction of the roll body R1 is correctly set. When the control unit 28 determines that the winding direction in the winding direction data matches the winding direction of the roll body R1 supported by the feeding shaft 32, the control unit 28 ends the determination processing. At this time, the control unit 28 may notify the user that the winding direction in the winding direction data matches the winding direction of the roll body R1 supported by the feeding shaft 32.

In step S13, when the moving direction of the tension bar 36 is downward, the control unit 28 determines that the winding direction in the winding direction data does not match the winding direction of the roll body R1 supported by the feeding shaft 32. When the moving direction of the tension bar 36 is downward, the control unit 28 transitions the processing to step S14.

In step S14, the control unit 28 notifies the user that the winding directions do not match. Specifically, the control unit 28 notifies the user that the winding direction in the winding direction data does not match the winding direction of the roll body R1 supported by the feeding shaft 32. For example, the control unit 28 executes the notification through the setting unit 15. After the notification, the control unit 28 ends the determination processing.

In step S15, the control unit 28 determines whether a rotation amount of the feeding shaft 32 reaches a first predetermined amount. When the rotation amount of the feeding shaft 32 reaches the first predetermined amount, the control unit 28 stops the feeding shaft 32. That is, in a case where movement of the tension bar 36 is not detected even when the rotation amount of the feeding shaft 32 reaches the first predetermined amount, the control unit 28 stops the feeding shaft 32. After stopping the feeding shaft 32, the control unit 28 transitions the processing to step S16. When the rotation amount of the feeding shaft 32 does not reach the first predetermined amount, the control unit 28 returns the processing to step S12. In step S12 and step S15, the control unit 28 rotates the feeding shaft 32 until movement of the tension bar 36 is detected or until the rotation amount of the feeding shaft 32 reaches the first predetermined amount.

When the winding direction in the winding direction data does not match the winding direction of the roll body R1 supported by the feeding shaft 32, the medium 99 is fed out in step S12 and step S15. In this case, there is a risk that the medium 99 is loosened so as to come into contact with a floor surface. Therefore, the control unit 28 limits the rotation amount of the feeding shaft 32 to the first predetermined amount. The first predetermined amount is an amount within which the medium 99 is expected not to come into contact with the floor surface when the medium 99 is fed out.

In step S16, the control unit 28 reversely rotates the feeding shaft 32. Specifically, the control unit 28 rotates the feeding shaft 32 in a reverse direction to the rotation direction in step S11. That is, the control unit 28 rotates the feeding shaft 32 in the reverse direction in a case where the tension bar 36 does not move even when the rotation amount of the feeding shaft 32 reaches the first predetermined amount in rotating the feeding shaft 32 so that the feeding shaft 32 winds up the medium 99 based on the winding direction data. It can also be said that, the control unit 28 rotates, in step S16, the feeding shaft 32 so as to feed out the medium 99 based on the winding direction data. In the example illustrated in FIG. 1, when the winding direction data indicates the inward winding, the control unit 28 rotates the feeding shaft 32 in the first direction D1. In the example illustrated in FIG. 1, when the winding direction data indicates the outward winding, the control unit 28 rotates the feeding shaft 32 in the second direction D2.

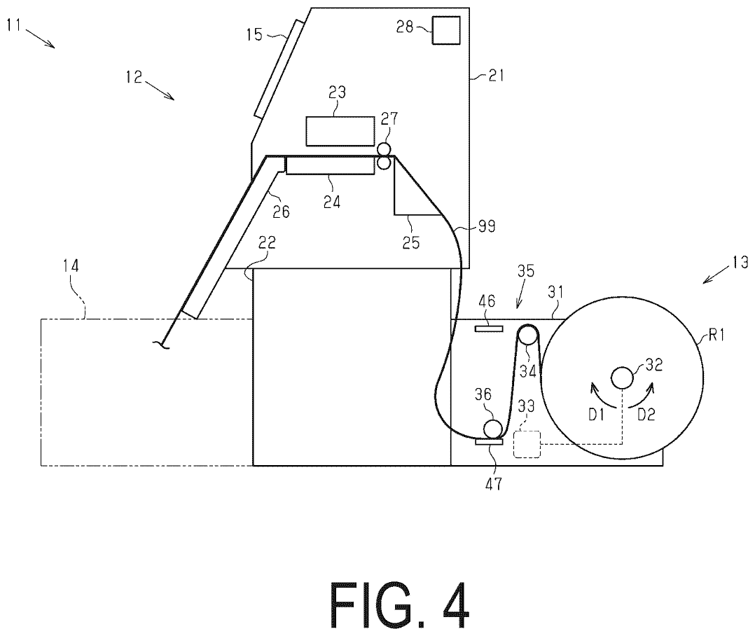

As illustrated in FIG. 4, the roll body R1 may be set at the feeding unit 13 with the medium 99 being loosened. When the roll body R1 is set at the feeding unit 13 with the medium 99 being loosened, the tension bar 36 may come into contact with the lower-side stopper 47. In this case, even when the feeding shaft 32 is rotated so as to feed out the medium 99, the tension bar 36 is not displaced downward. That is, when the winding direction in the winding direction data does not match the winding direction of the roll body R1 supported by the feeding shaft 32, the tension bar 36 does not move downward even when the feeding shaft 32 rotates so as to feed out the medium 99 in step S11 in some cases. In this case, movement of the tension bar 36 is not detected in step S12. Thus, in step S16, the control unit 28 reversely rotates the feeding shaft 32.

In step S17, the control unit 28 determines whether the tension bar 36 has moved upward as illustrated in FIG. 3. The control unit 28 determines whether the tension bar 36 has moved upward based on a detection result by the detection unit 45. In the case where the winding direction in the winding direction data does not match the winding direction of the roll body R1 supported by the feeding shaft 32, the medium 99 may be wound by the feeding shaft 32 when the feeding shaft 32 rotates in the reverse direction. The tension bar 36 moves upward when the medium 99 is wound by the feeding shaft 32. Therefore, when the tension bar 36 moves upward, the control unit 28 determines that the winding direction indicated by the winding direction data does not match the winding direction of the roll body R1 supported by the feeding shaft 32. In this case, the control unit 28 transitions the processing to step S14. When the tension bar 36 does not move upward, the control unit 28 transitions the processing to step S18.

In step S18, the control unit 28 determines whether a reverse rotation amount of the feeding shaft 32 has reached a second predetermined amount. When the reverse rotation amount of the feeding shaft 32 does not reach the second predetermined amount, the control unit 28 returns the processing to step S17. In step S17 and step S18, the control unit 28 reversely rotates the feeding shaft 32 until the tension bar 36 moves upward or until the reverse rotation amount of the feeding shaft 32 reaches the second predetermined amount.

The second predetermined amount is an amount larger than the first predetermined amount. Therefore, when the feeding shaft 32 rotates in the reverse direction by the second predetermined amount in step S17 and step S18, a phase of the feeding shaft 32 is displaced in a reverse direction to that at the start of the determination processing. Specifically, the second predetermined amount is an amount twice the first predetermined amount. The first predetermined amount and the second predetermined amount are represented by absolute values. In step S17 and step S18, the control unit 28 reversely rotates the feeding shaft 32 by the first predetermined amount. As a result, the phase of the feeding shaft 32 returns to that at the start of the determination processing. In step S17 and step S18, the control unit 28 further reversely rotates the feeding shaft 32 by the first predetermined amount. As a result, the phase of the feeding shaft 32 is displaced in the reverse direction.

In step S18, when the reverse rotation amount of the feeding shaft 32 reaches the second predetermined amount, the control unit 28 determines that an error has occurred. That is, in a case where the tension bar 36 does not move upward even when the reverse rotation amount of the feeding shaft 32 reaches the second predetermined amount, the control unit 28 determines that an error has occurred. The error mentioned here includes, for example, that the roll body R1 is not supported by the feeding shaft 32, that the medium 99 is torn between the roll body R1 and the tension bar 36, and that the medium 99 is jammed between the roll body R1 and the tension bar 36, and does not include that the winding direction data of the roll body R1 does not match the winding direction of the roll body R1 supported by the feeding shaft 32. When the reverse rotation amount of the feeding shaft 32 reaches the second predetermined amount, the control unit 28 stops the feeding shaft 32. After stopping the feeding shaft 32, the control unit 28 transitions the processing to step S19.

In step S19, the control unit 28 notifies the user that the error has occurred. For example, the control unit 28 executes the notification through the setting unit 15. After the notification, the control unit 28 ends the determination processing.

Next, one example of activation processing will be described. The activation processing is executed when power of the printing apparatus 11 is turned on. The activation processing is, similar to determination processing, includes processing of determining whether winding direction data of the roll body R1 matches a winding direction of the roll body R1 supported by the feeding shaft 32. When the power of the printing apparatus 11 is turned on, in addition to the winding direction of the roll body R1, inspection of the printing section 23, inspection of the medium 99, inspection of the roll body R1, and the like are executed. Therefore, the activation processing is required to be completed in a shorter time as compared to the determination processing. By completing the activation processing in a short time, a time required for activation of the printing apparatus 11 can be shortened.

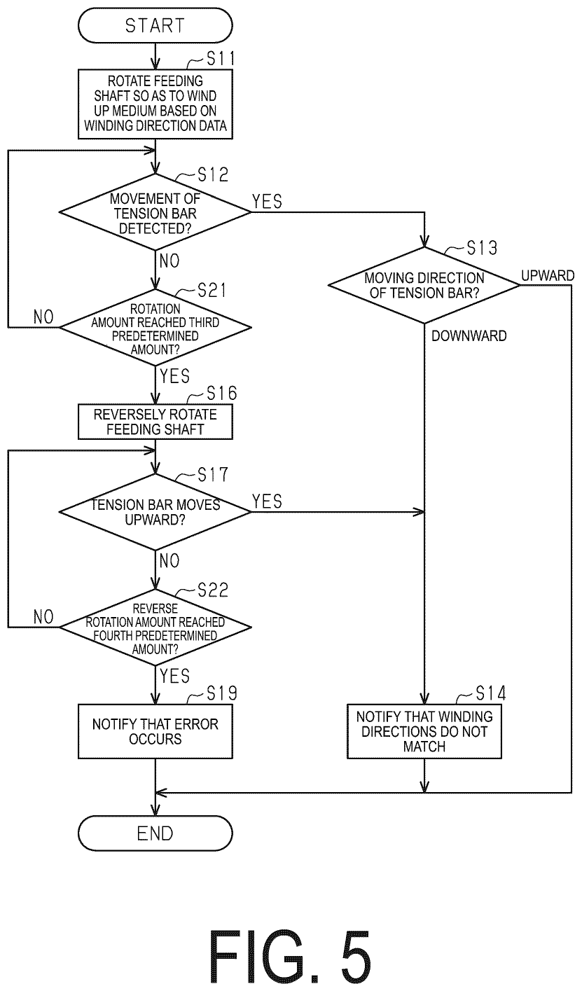

The activation processing is basically similar processing to the determination processing. Specifically, the activation processing is different from the determination processing only in a predetermined amount. To be more specific, in a flowchart illustrated in FIG. 5, only processing in step S21 and processing in step S22 are different. Therefore, differences between the activation processing and the determination processing will be mainly described.

As illustrated in FIG. 5, when the power of the printing apparatus 11 is turned on, in step S11, the control unit 28 rotates the feeding shaft 32 so as to wind up the medium 99 based on winding direction data.

In step S21, the control unit 28 determines whether a rotation amount of the feeding shaft 32 has reached a third predetermined amount. When the rotation amount of the feeding shaft 32 reaches the third predetermined amount, the control unit 28 stops the feeding shaft 32. That is, in a case where movement of the tension bar 36 is not detected even when the rotation amount of the feeding shaft 32 reaches the third predetermined amount, the control unit 28 stops the feeding shaft 32. After stopping the feeding shaft 32, the control unit 28 transitions the processing to step S16. When the rotation amount of the feeding shaft 32 does not reach the third predetermined amount, the control unit 28 returns the processing to step S12. In step S12 and step S21, the control unit 28 rotates the feeding shaft 32 until movement of the tension bar 36 is detected or until the rotation amount of the feeding shaft 32 reaches the third predetermined amount.

The third predetermined amount is an amount smaller than the first predetermined amount. Therefore, in the activation processing, a small rotation amount of the feeding shaft 32 is sufficient as compared to the determination processing. As a result, a time required for the activation processing is shortened as compared to the determination processing.

In step S16, the control unit 28 reversely rotates the feeding shaft 32. That is, in a case where the tension bar 36 does not move even when the feeding shaft 32 rotates by the third predetermined amount in step S21, the control unit 28 reversely rotates the feeding shaft 32 in step S16.

In step S22, the control unit 28 determines whether the rotation amount of the feeding shaft 32 has reached a fourth predetermined amount. When the rotation amount of the feeding shaft 32 reaches the fourth predetermined amount, the control unit 28 determines that an error has occurred. That is, in a case where the tension bar 36 does not move upward even when the reverse rotation amount of the feeding shaft 32 reaches the fourth predetermined amount, the control unit 28 determines that an error has occurred. When the rotation amount of the feeding shaft 32 reaches the fourth predetermined amount, the control unit 28 stops the feeding shaft 32. After stopping the feeding shaft 32, the control unit 28 transitions the processing to step S19. When the rotation amount of the feeding shaft 32 does not reach the fourth predetermined amount, the control unit 28 returns the processing to step S17. In step S17 and step S22, the control unit 28 reversely rotates the feeding shaft 32 until the tension bar 36 moves upward or until the rotation amount of the feeding shaft 32 reaches the fourth predetermined amount.

The fourth predetermined amount is an amount larger than the second predetermined amount. Therefore, in the activation processing, a small reverse rotation amount of the feeding shaft 32 is sufficient as compared to the determination processing. As a result, a time required for the activation processing is shortened as compared to the determination processing. In one example, the fourth predetermined amount is an amount twice the third predetermined amount. The third predetermined amount and the fourth predetermined amount are represented by absolute values.

### Operations and Effects of Example

Next, operations and effects of the above-mentioned examples are described.
(1) The control unit 28 rotates the feeding shaft 32 so as to wind up the medium 99 based on winding direction data. When the tension bar 36 moves upward by the feeding shaft 32 rotating, the control unit 28 determines that a winding direction in the winding direction data matches a winding direction of the roll body R1 supported by the feeding shaft 32. When the tension bar 36 moves downward by the feeding shaft 32 rotating, the control unit 28 determines that the winding direction in the winding direction data does not match the winding direction of the roll body R1 supported by the feeding shaft 32. When the feeding shaft 32 rotates so as to wind up the medium 99, the tension bar 36 moves upward by the medium 99 being pulled. When the feeding shaft 32 rotates so as to feed out the medium 99, the tension bar 36 moves downward by the medium 99 being loosened. According to the above-described method, it is possible to determine whether the winding direction in the winding direction data matches the winding direction of the roll body R1 supported by the feeding shaft 32 based on the movement of the tension bar 36. Therefore, it can be determined that the winding direction of the roll body R1 is correctly set.
(2) The control unit 28 rotates the feeding shaft 32 in a reverse direction in a case where the tension bar 36 does not move even when a rotation amount of the feeding shaft 32 reaches the first predetermined amount in rotating the feeding shaft 32 so as to wind up the medium 99 based on the winding direction data. When the tension bar 36 moves upward by the feeding shaft 32 rotating in the reverse direction, the control unit 28 determines that the winding direction in the winding direction data does not match the winding direction of the roll body R1 supported by the feeding shaft 32. In a case where the medium 99 is loosened between the feeding shaft 32 and the printing section 23, the tension bar 36 does not move downward even when the medium 99 is fed out from the roll body R1 by the feeding shaft 32 rotating in some cases. Therefore, there is a risk that it cannot be determined that the winding direction in the winding direction data does not match the winding direction of the roll body R1 supported by the feeding shaft 32. According to the above-described method, when the medium 99 is wound up by the feeding shaft 32 rotating in the reverse direction, the tension bar 36 moves upward. Therefore, by rotating the feeding shaft 32 in the reverse direction, it can be determined that the winding direction in the winding direction data does not match the winding direction of the roll body R1 supported by the feeding shaft 32.
(3) In a case where the tension bar 36 does not move even when a reverse rotation amount of the feeding shaft 32 reaches the second predetermined amount larger than the first predetermined amount, the control unit 28 determines that an error has occurred. In a case where the tension bar 36 does not move even when the feeding shaft 32 is rotated in both the directions, there is a high possibility that an error has occurred. According to the above-described method, it is possible to determine that an error has occurred.
(4) When a power of the printing apparatus 11 is turned on, the control unit 28 rotates the feeding shaft 32 so as to wind up the medium 99 based on the winding direction data. In a case where the tension bar 36 does not move even when the rotation amount of the feeding shaft 32 reaches the third predetermined amount smaller than the first predetermined amount, the control unit 28 rotates the feeding shaft 32 in the reverse direction. In a case where the tension bar 36 does not move even when the reverse rotation amount of the feeding shaft 32 reaches the fourth predetermined amount larger than the third predetermined amount, the control unit 28 determines that an error has occurred. At the time of power-on, when the feeding shaft 32 rotates for a long time, a time required to start up the printing apparatus 11 becomes long. According to the configuration described above, since the rotation amount and the reverse rotation amount of the feeding shaft 32 are small at the time of power-on, the time required to start up the printing apparatus 11 is shortened.

### Modifications

The above-mentioned examples may be modified as follows for implementation. The above-mentioned examples and the following modifications may be combined for implementation insofar as they are not technically inconsistent.

The control unit 28 may rotate the feeding shaft 32 so as to feed out the medium 99 based on winding direction data. The control unit 28 may determine that a winding direction in the winding direction data matches a winding direction of the roll body R1 supported by the feeding shaft 32 when the tension bar 36 moves downward by the feeding shaft 32 rotating. The control unit 28 may determine that the winding direction in the winding direction data does not match the winding direction of the roll body R1 supported by the feeding shaft 32 when the tension bar 36 moves upward by the feeding shaft 32 rotating. Also in the modification, the control unit 28 can determine whether the winding direction of the roll body R1 is correctly set.

The printing apparatus 11 may be controlled by an external device. In this case, the external device may execute the determination processing and the activation processing. Further, winding direction data may be set in the external device.

The liquid that the printing section 23 discharges is not limited to ink, and may be, for example, a liquid body in which particles of a functional material are dispersed in or mixed with a liquid. For example, the printing section 23 may discharge a liquid body including, in a dispersed or dissolved form, a material such as an electrode material or a pixel material used in manufacturing a liquid crystal display, an electroluminescence display, a surface emitting display, or the like.

### Technical Ideas

The following describes technical ideas and operational effects that are derived from the above-described examples and modifications.
(A) A method for controlling a printing apparatus is a method for controlling a printing apparatus in which winding direction data indicating a winding direction of a roll body around which a medium is wound is set, the method including rotating a feeding shaft that supports the roll body so as to wind up the medium based on the winding direction data, and determining that the winding direction in the winding direction data matches a winding direction of the roll body supported by the feeding shaft when a tension bar that applies tension to the medium between a printing section that performs printing on the medium and the feeding shaft moves upward by the feeding shaft rotating, and determining that the winding direction in the winding direction data does not match the winding direction of the roll body supported by the feeding shaft when the tension bar moves downward by the feeding shaft rotating. When the feeding shaft rotates so as to wind up the medium, the tension bar moves upward by the medium being pulled. When the feeding shaft rotates so as to feed out the medium, the tension bar moves downward by the medium being loosened. According to the above-described method, it is possible to determine whether the winding direction in the winding direction data matches the winding direction of the roll body supported by the feeding shaft based on the movement of the tension bar. Therefore, it can be determined that the winding direction of the roll body is correctly set.
(B) Control information about the printing apparatus described above may include rotating the feeding shaft in a reverse direction in a case where the tension bar does not move even when a rotation amount of the feeding shaft reaches a predetermined amount in rotating the feeding shaft so as to wind up the medium based on the winding direction data, and determining that the winding direction in the winding direction data does not match the winding direction of the roll body supported by the feeding shaft when the tension bar moves upward by the feeding shaft being rotated in the reverse direction. In a case where the medium is loosened between the feeding shaft and the printing section, the tension bar does not move downward even when the medium is fed out from the roll body by the feeding shaft rotating in some cases. Therefore, there is a risk that it cannot be determined that the winding direction in the winding direction data does not match the winding direction of the roll body supported by the feeding shaft. According to the above-described method, when the medium is wound up by the feeding shaft rotating in the reverse direction, the tension bar moves upward. Therefore, by rotating the feeding shaft in the reverse direction, it can be determined that the winding direction in the winding direction data does not match the winding direction of the roll body supported by the feeding shaft.
(C) In a method for controlling the printing apparatus described above, the predetermined amount may be a first predetermined amount, and the method for controlling the printing apparatus may include determining that an error has occurred in a case where the tension bar does not move even when a reverse rotation amount of the feeding shaft reaches a second predetermined amount larger than the first predetermined amount. In a case where the tension bar does not move even when the feeding shaft is rotated in both the directions, there is a high possibility that an error has occurred. According to the above-described method, it is possible to determine that an error has occurred.
(D) The method for controlling the printing apparatus described above may include rotating the feeding shaft so as to wind up the medium based on the winding direction data when power of the printing apparatus is turned on, rotating the feeding shaft in a reverse direction in a case where the tension bar does not move even when the rotation amount of the feeding shaft reaches a third predetermined amount smaller than the first predetermined amount in rotating the feeding shaft so as to wind up the medium based on the winding direction data when the power of the printing apparatus is turned on, and determining that the error occurs in a case where the tension bar does not move even when the reverse rotation amount of the feeding shaft reaches a fourth predetermined amount larger than the third predetermined amount. At the time of power-on, when the feeding shaft rotates for a long time, a time required to start up the printing apparatus becomes long. According to the configuration described above, since the rotation amount and the reverse rotation amount of the feeding shaft are small at the time of power-on, the time required to start up the printing apparatus is shortened.
(E) A method for controlling a printing apparatus is a method for controlling a printing apparatus in which winding direction data indicating a winding direction of a roll body around which a medium is wound is set, the method including rotating a feeding shaft that supports the roll body so as to feed out the medium based on the winding direction data, and determining that the winding direction in the winding direction data matches a winding direction of the roll body supported by the feeding shaft when a tension bar that applies tension to the medium between a printing section that performs printing on the medium and the feeding shaft moves downward by the feeding shaft rotating, and determining that the winding direction in the winding direction data does not match the winding direction of the roll body supported by the feeding shaft when the tension bar moves upward by the feeding shaft rotating. When the feeding shaft rotates so as to feed out the medium, the tension bar moves downward by the medium being loosened. When the feeding shaft rotates so as to wind up the medium, the tension bar moves upward by the medium being pulled. According to the above-described method, it is possible to determine whether the winding direction in the winding direction data matches the winding direction of the roll body supported by the feeding shaft based on the movement of the tension bar. Therefore, it can be determined that the winding direction of the roll body is correctly set.

What is claimed is:

1. A method for controlling a printing apparatus in which winding direction data indicating a winding direction of a roll body around which a medium is wound is set, the method comprising:
rotating a feeding shaft that supports the roll body so as to wind up the medium based on the winding direction data; and
determining that the winding direction in the winding direction data matches a winding direction of the roll body supported by the feeding shaft when a tension bar that applies tension to the medium between a printing section that performs printing on the medium and the feeding shaft, moves upward by the feeding shaft rotating, and determining that the winding direction in the winding direction data does not match the winding direction of the roll body supported by the feeding shaft when the tension bar moves downward by the feeding shaft rotating.

2. The method for controlling the printing apparatus according to claim 1, comprising:
rotating the feeding shaft in a reverse direction in a case where the tension bar does not move even when a rotation amount of the feeding shaft reaches a predetermined amount in rotating the feeding shaft so as to wind up the medium based on the winding direction data; and
determining that the winding direction in the winding direction data does not match the winding direction of the roll body supported by the feeding shaft when the tension bar moves upward by the feeding shaft rotating in the reverse direction.

3. The method for controlling the printing apparatus according to claim 2, wherein
the predetermined amount is a first predetermined amount, and
the method for controlling the printing apparatus includes determining that an error occurs in a case where the tension bar does not move even when a reverse rotation amount of the feeding shaft reaches a second predetermined amount larger than the first predetermined amount.

4. The method for controlling the printing apparatus according to claim 3, comprising:
rotating the feeding shaft so as to wind up the medium based on the winding direction data when power of the printing apparatus is turned on;
rotating the feeding shaft in the reverse direction in a case where the tension bar does not move even when the rotation amount of the feeding shaft reaches a third predetermined amount smaller than the first predetermined amount in rotating the feeding shaft so as to wind up the medium based on the winding direction data when the power of the printing apparatus is turned on; and
determining that the error occurs in a case where the tension bar does not move even when the reverse rotation amount of the feeding shaft reaches a fourth predetermined amount larger than the third predetermined amount.

5. A method for controlling a printing apparatus in which winding direction data indicating a winding direction of a roll body around which a medium is wound is set, the method comprising:
rotating a feeding shaft that supports the roll body so as to feed out the medium based on the winding direction data; and
determining that the winding direction in the winding direction data matches a winding direction of the roll body supported by the feeding shaft when a tension bar that applies tension to the medium between a printing section that performs printing on the medium and the feeding shaft, moves downward by the feeding shaft rotating, and determining that the winding direction in the winding direction data does not match the winding direction of the roll body supported by the feeding shaft when the tension bar moves upward by the feeding shaft rotating.
